(19) United States
(12) Patent Application Publication
(10) Pub. No.: US 2025/0287261 A1
(43) Pub. Date: Sep. 11, 2025

(54) CELL MANAGEMENT METHODS AND USER EQUIPMENT

(71) Applicant: BEIJING XIAOMI MOBILE SOFTWARE CO., LTD., Beijing (CN)

(72) Inventors: Yumin WU, Beijing (CN); Yi XIONG, Beijing (CN)

(73) Assignee: BEIJING XIAOMI MOBILE SOFTWARE CO., LTD., Beijing (CN)

(21) Appl. No.: 18/860,625

(22) PCT Filed: Apr. 27, 2022
(86) PCT No.: PCT/CN2022/089680

§ 371 Date: Oct. 25, 2024

(51) Int. Cl. H04W 28/086

(52) U.S. Cl. CPC H04W 28/086

(57) ABSTRACT

A cell management method is performed by a user equipment (UE). The method includes: obtaining configuration information of at least one of at least one candidate cell or at least one candidate cell group configured by a network device; determining an initial configuration state of at least one of a candidate cell or a candidate cell group, wherein the initial configuration state comprises at least one of a configured initial activation state of the candidate cell, a configured initial activation state of the candidate cell group, an initial cell type, or an initial cell group type; and managing at least one of the candidate cell or the candidate cell group based on the configuration information and the initial configuration state.

### CROSS-REFERENCE TO RELATED APPLICATION

This application is the U.S. National Stage Application of International Application No. PCT/CN2022/089680, filed on Apr. 27, 2022, the entire disclosure of which is incorporated herein by reference for all purposes.

### TECHNICAL FIELD

The present disclosure relates to the field of communication technologies, and in particular to a cell management method, a cell management apparatus, a device, and a storage medium.

### BACKGROUND

In communication systems, a network device usually configures configuration information of candidate cells and/or candidate cell groups for a user equipment (UE), so that the UE can subsequently perform selective activation of cells and/or cell groups based on the configuration information of the candidate cells and/or the candidate cell groups by receiving signaling for activation or deactivation transmitted by the network device.

In the related art, how to perform selective activation of cells and/or cell groups is a technical problem that needs to be solved urgently.

### SUMMARY

In a first aspect of the present disclosure, a cell management method is provided, which is performed by a user equipment, including:
obtaining configuration information of at least one of at least one candidate cell or at least one candidate cell group configured by a network device;
determining an initial configuration state of at least one of a candidate cell or a candidate cell group, where the initial configuration state includes at least one of a configured initial activation state of the candidate cell, a configured initial activation state of the candidate cell group, an initial cell type, or an initial cell group type; and
managing at least one of the candidate cell or the candidate cell group based on the configuration information and the initial configuration state.

In a second aspect of the present disclosure, a cell management method is provided, which is performed by a network device, including:
configuring configuration information of at least one of at least one candidate cell or at least one candidate cell group for a user equipment (UE); and
configuring an initial configuration state of at least one of a candidate cell or of a candidate cell group for the UE, where the initial configuration state includes at least one of a configured initial activation state of the candidate cell, a configured initial activation state of the candidate cell group, an initial cell type, or an initial cell group type.

In third aspect of the present disclosure, a UE is provided, which includes a processor and a memory, where a computer program is stored in the memory, and the processor is configured to execute the computer program stored in the memory to cause the communication device to perform the method provided in the first aspect described above.

### BRIEF DESCRIPTION OF THE DRAWINGS

The above and/or additional aspects and advantages of the present disclosure will become apparent and easy to understand from the following description of the embodiments in conjunction with the drawings.

FIGS. 1a-1d are flow charts of a cell management method according to an embodiment of the present disclosure.

FIG. 2 is a flow chart of a cell management method according to another embodiment of the present disclosure.

FIG. 3a-3c are flow charts of a cell management method according to another embodiment of the present disclosure.

FIG. 4 is a flow chart of a cell management method according to another embodiment of the present disclosure.

FIG. 5 is a structural diagram of a cell management apparatus according to another embodiment of the present disclosure.

FIG. 6 is a structural diagram of a cell management apparatus according to another embodiment of the present disclosure.

FIG. 7 is a block diagram of user equipment according to an embodiment of the present disclosure.

FIG. 8 is a block diagram of a network side device according to an embodiment of the present disclosure.

### DETAILED DESCRIPTION

Exemplary embodiments will be described in detail hereinafter, examples of which are illustrated in the drawings. When the drawings are referred to in the following description, unless otherwise indicated, same numerals in different drawings represent same or similar elements. The implementations described in the following exemplary embodiments do not represent all implementations consistent with the present disclosure. Rather, they are merely examples of devices and methods consistent with some aspects of the present disclosure as recited in the appended claims.

The terms used in the present disclosure are for the purpose of describing particular embodiments only and are not intended to limit the present disclosure. The singular forms “a” and “the” used in the present disclosure and the appended claims are intended to include the plural forms as well, unless otherwise indicated in the context clearly. It should also be understood that the term “and/or” used herein refers to the fact that any or all possible combinations of one or more of the associated listed items may be included.

It should be understood that although the terms “first”, “second”, “third”, etc., may be used in the present disclosure to describe various pieces of information, such information should not be limited to these terms. These terms are used only to distinguish pieces of information that are of the same type. For example, without departing from the scope of the present disclosure, first information may also be referred to as second information, and similarly, second information may also be referred to as first information. Depending on the context, for example, the expressions “if” and “on condition that” used herein may be interpreted as “in a case that” or “when” or “in response to determining”.

A cell management method, a cell management apparatus, a device and a storage medium according to the embodiments of the present disclosure are described in detail hereinafter with reference to the drawings.

In conclusion, in the cell management method, the cell management apparatus, the device and the storage medium provided in the embodiments of the present disclosure, the UE may obtain the configuration information of at least one candidate cell and/or at least one candidate cell group configured by the network device, then the UE may determine the initial configuration state of a candidate cell and/or of a candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

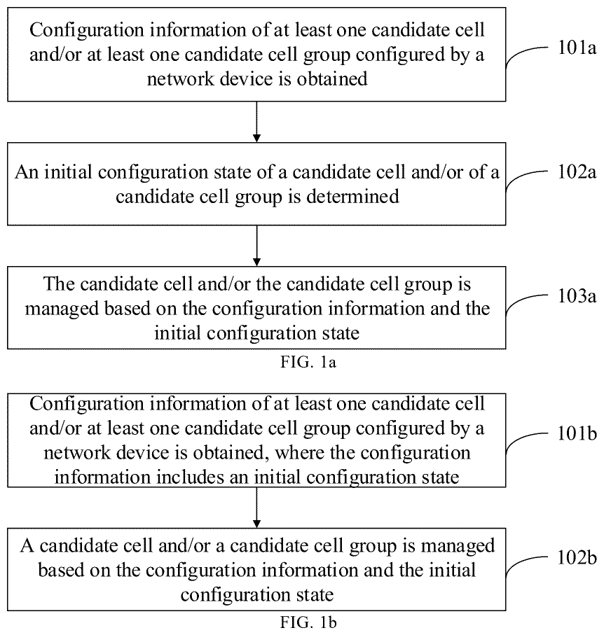

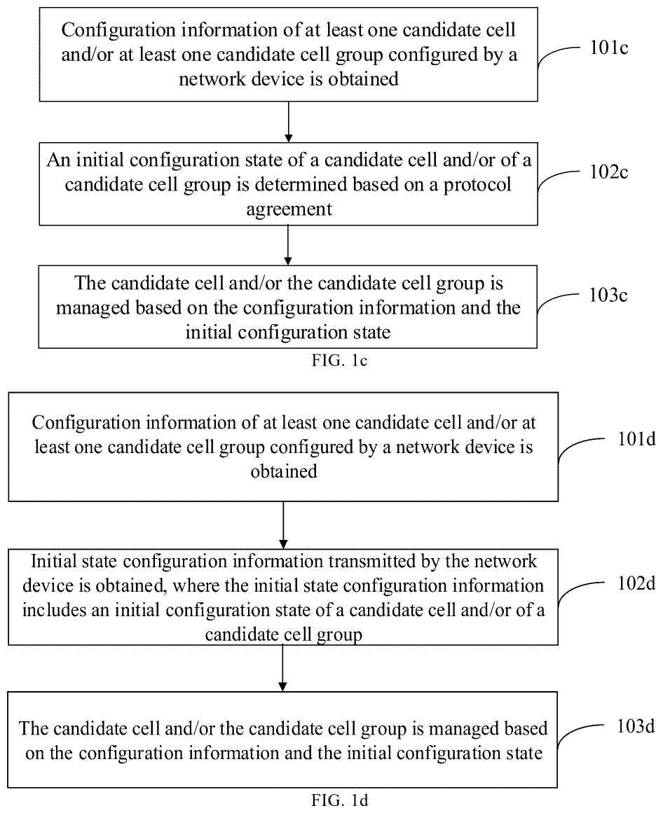

FIG. 1a is a flow chart of a cell management method according to embodiments of the present disclosure. The method is performed by a UE, and may be used for downlink positioning. As shown in FIG. 1a, the method may include the following steps.

Step 101a: configuration information of at least one candidate cell and/or at least one candidate cell group configured by a network device is obtained.

In an embodiment of the present disclosure, the UE may refer to a device that provides voice and/or data connectivity for a user. The user equipment may communicate with one or more core networks via an RAN (Radio Access Network). The UE may be an Internet-of-Things terminal, such as a sensor device, a mobile phone (or referred to as a “cellular” phone), and a computer with an Internet-of-Things terminal. For example, it may be a fixed, portable, pocket-sized, handheld, computer built-in, or vehicle-mounted device. For example, it may be a station (STA), a subscriber unit, a subscriber station, a mobile station, a mobile, a remote station, an access point, a remote terminal, an access terminal, a user terminal or a user agent. Or, the UE may be a device of an unmanned aerial vehicle. Or, the UE may be a vehicle-mounted device, for example, a trip computer with a wireless communication function, or a wireless terminal externally connected to a trip computer. Or, the UE may be a roadside device, for example, a street lamp, a signal lamp or other roadside device with a wireless communication function.

In an embodiment of the present disclosure, the configuration information may explicitly include a configuration identifier of each candidate cell and/or candidate cell group. Based on the above, in an embodiment of the present disclosure, the configuration information may include at least one of:
a configuration identifier of the candidate cell;
a configuration identifier of the candidate cell group;
cell configuration of the candidate cell (the cell configuration may be, for example, configuration information such as a C-RNTI (cell radio network temporary identifier) or an uplink transmission power); or,
cell group configuration of the candidate cell group (the cell group configuration may be, for example, configuration information such as a C-RNTI or an uplink transmission power).

Specifically, the configuration information may be configured by the network device to the UE through an RRC (Radio Resource Control) message, and the RRC message may be, for example, an RRC Reconfiguration message. Furthermore, in an embodiment of the present disclosure, the configuration information may be a configuration list, and each column of the configuration list may include an RRC Reconfiguration message. The RRC Reconfiguration message included in the column of the list may include a configuration identifier of one candidate cell and cell configuration of the candidate cell, or the RRC Reconfiguration message included in the column of the list may include a configuration identifier of one candidate cell group and cell group configuration of the candidate cell group.

Furthermore, in another embodiment of the present disclosure, the configuration information may not explicitly include the configuration identifier of the each candidate cell and/or candidate cell group, but may implicitly indicate the configuration identifier of the each candidate cell and/or candidate cell group. Therefore, the configuration information may include only at least one of:
cell configuration of the candidate cell; or,
cell group configuration of the candidate cell group.

Furthermore, the way the configuration information implicitly indicates the configuration identifier of the each candidate cell and/or candidate cell group may be: in a case that the configuration information is a configuration list, each column of the configuration list corresponds to an index, and each column of the configuration list correspondingly includes cell configuration of one candidate cell or cell group configuration of one candidate cell group, where an index of a column corresponding to each candidate cell is used to implicitly indicate a configuration identifier of the each candidate cell, and an index of a column corresponding to each candidate cell group is used to implicitly indicate a configuration identifier of the each candidate cell group.

For example, in a case that an index corresponding to a first list item in the configuration list is “0”, the configuration identifier of the candidate cell (or cell group) included in the first list item is “0”, and in a case that an index corresponding to a second list item in the configuration list is “1”, the configuration identifier of the candidate cell (or cell group) included in the second list item is “1”.

Step 102a: an initial configuration state of a candidate cell and/or of a candidate cell group is determined.

In an embodiment of the present disclosure, the initial configuration state may include at least one of a configured initial activation state of the candidate cell, a configured initial activation state of the candidate cell group, an initial cell type, or an initial cell group type.

In an embodiment of the present disclosure, the configured initial activation state of the candidate cell may be any one of a candidate activation state; the configured initial activation state of the candidate cell group may also be any one of the candidate activation state; the candidate activation state may include at least one of:
an activated state; or,
a deactivated state.

Furthermore, in an embodiment of the present disclosure, the initial cell type may be any one of a candidate cell type; the candidate cell type may include at least one of:
a PCell (Primary Cell);
a PSCell (Primary Secondary Cell);
an SpCell (Special Cell);
an SCell (Secondary Cell);
an SCell of an MCG (Master Cell Group); or,
an SCell of an SCG (Secondary Cell Group).

Furthermore, in an embodiment of the present disclosure, the initial cell group type may be any one of a candidate cell group type; the candidate cell group type may include at least one of:
an MCG; or,
an SCG.

Furthermore, it should be noted that, in an embodiment of the present disclosure, the initial configuration state of a candidate cell and/or of a candidate cell group needs to satisfy at least one of following conditions:
a quantity of candidate cell with an initial cell type of PCell and with a configured initial activation state of “activated” is 1;
a quantity of candidate cell with an initial cell type of PSCell and with a configured initial activation state of “activated” is 1;
in a case that a configured initial activation state of a candidate cell with an initial cell type of PCell is “deactivated”, configured initial activation states of other cells belonging to a same cell group as the candidate cell are set to “deactivated”;
in a case that a configured initial activation state of a candidate cell with an initial cell type of PSCell is “deactivated”, configured initial activation states of other cells belonging to a same cell group as the candidate cell are set to “deactivated”;
a quantity of candidate cell group with an initial cell group type of MCG and with a configured initial activation state of “activated” is 1; or,
a quantity of candidate cell group with an initial cell group type of SCG and with a configured initial activation state of “activated” is 1.

In addition, in an embodiment of the present disclosure, the determining by the UE the initial configuration state of a candidate cell and/or of a candidate cell group may include at least one of:
determining the initial configuration state of the candidate cell and/or of the candidate cell group based on the configuration information, where the configuration information includes the initial configuration state of the candidate cell and/or of the candidate cell group;
determining the initial configuration state of the candidate cell and/or of the candidate cell group based on a protocol agreement; or,
obtaining initial state configuration information transmitted by the network device, and determining the initial configuration state of the candidate cell and/or of the candidate cell group based on the initial state configuration information, where the initial state configuration information includes the initial configuration state of the candidate cell and/or of the candidate cell group.

Step 103a: the candidate cell and/or the candidate cell group is managed based on the configuration information and the initial configuration state.

In an embodiment of the present disclosure, the managing the candidate cell based on the configuration information and the initial configuration state may include: first, determining a management behavior for the candidate cell in each different initial configuration state based on a protocol agreement, then, managing the candidate cell based on the determined management behavior.

Specifically, in an embodiment of the present disclosure, in response to the initial cell type of the candidate cell being a PCell, a PSCell or an SpCell, the corresponding management behavior is determined as: directly activating or deactivating the candidate cell based on the configured initial activation state. For example, if the configured initial activation state of the candidate cell is “activated”, the corresponding management behavior is determined as: the UE restores or enables the cell configuration of the candidate cell to activate the candidate cell, and setts a cell type of the candidate cell to the corresponding initial cell type (i.e., PCell or PSCell or SpCell); if the configured initial activation state of the candidate cell is “deactivated”, the corresponding management behavior is determined as: the UE suspends or deletes the cell configuration of the candidate cell to deactivate the candidate cell.

For example, in an embodiment of the present disclosure, in response to the initial configuration state of the candidate cell-1 with a configuration identifier of “1” determined by the UE being as follows: the initial cell type being a PCell and the configured initial activation state being “activated”, the UE may restore or enable the cell configuration of the candidate cell-1 to activate the candidate cell-1, and set the cell type of the candidate cell-1 to PCell.

In another embodiment of the present disclosure, in response to the initial cell type of the candidate cell being an SCell or an MCG SCell or an SCG SCell, in a case that the configured initial activation state of the candidate cell is “activated”, the management behavior is determined as: managing the candidate cell based on a secondary cell state configured by the network device and/or agreed upon in a protocol, and setting a type of the candidate cell to the corresponding initial cell type (i.e., SCell or MCG SCell or SCG SCell), where the secondary cell state includes an activated state, a deactivated state or a sleep state.

It should be noted that, in a case that it is configured by the network device that the initial activation state of the candidate cell with an initial cell type of SCell or MCG SCell or SCG SCell is “activated”, it means that the network device indicates to restore or enable the cell configuration of the candidate cell. In this case, the UE restores or enables the cell configuration of the candidate cell, and sets the type of the candidate cell to SCell or MCG SCell or SCG SCell. It should be noted that, for the SCell, after determining to restore or enable the cell configuration of the SCell, the UE needs to further determine the secondary cell state based on configuration of the network device and/or a protocol agreement, and further manage the SCell based on the secondary cell state. Specifically, in a case that the secondary cell state is an “activated state”, the UE restores or enables the configuration of the candidate cell, and receives and transmits data or control channels of the SCell based on the cell configuration of the candidate cell; in a case that the secondary cell state is a “deactivated state”, the UE only restores or enables the configuration of the candidate cell, but stops receiving and transmitting data or control channels of the SCell; in a case that the secondary cell state is a “sleep state”, the UE restores or enables the configuration of the candidate cell, stops receiving and transmitting data or control channels of the SCell, and also performs measurement reporting of the SCell.

For example, in an embodiment of the present disclosure, in response to the initial configuration state of the candidate cell-1 with a configuration identifier of “1” determined by the UE being as follows: the initial cell type being SCell and the configured initial activation state being “activated”, and assuming that the UE determines that the secondary cell state is a “sleep state” based on configuration of the network device and/or a protocol agreement, the UE may set the cell type of the candidate cell-1 to PCell and restore or enable the cell configuration of the candidate cell-1, but stop receiving and transmitting data or control channels of the candidate cell-1 and only perform measurement reporting of the candidate cell-1.

In another embodiment of the present disclosure, in response to the initial cell type of the candidate cell being an SCell or an MCG SCell or an SCG SCell, in a case that the configured initial activation state of the candidate cell is “deactivated”, the management behavior is determined as: managing the candidate cell based on a secondary cell state configured by the network device and/or agreed upon in a protocol, and setting a type of the candidate cell to the corresponding initial cell type (i.e., SCell or MCG SCell or SCG SCell, where the secondary cell state includes a deactivated state or a sleep state.

It should be noted that, in a case that it is configured by the network device that the initial activation state of the candidate cell with an initial cell type of SCell or MCG SCell or SCG SCell is “deactivated”, it means that the network device indicates to suspend or delete the cell configuration of the candidate cell. In this case, the UE suspends or deletes the cell configuration of the candidate cell, and also sets the type of the candidate cell to SCell or MCG SCell or SCG SCell. It should be noted that, for the SCell, after determining to suspend or delete the cell configuration of the SCell, the UE needs to further determine the secondary cell state based on configuration of the network device and/or a protocol agreement, and further manage the SCell based on the secondary cell state. Specifically, in a case that the secondary cell state is a “deactivated state”, after the UE suspends or deletes the configuration of the candidate cell, the UE stops receiving or transmitting data or control channels of the SCell; in a case that the secondary cell state is a “sleep state”, after the UE suspends or deletes the configuration of the candidate cell, the UE stops receiving or transmitting data or control channels of the SCell, and also performs measurement reporting of the SCell.

Furthermore, in another embodiment of the present disclosure, the managing the candidate cell group based on the configuration information and the initial configuration state may include: first, determining a management behavior for the candidate cell group in each different initial configuration state based on a protocol agreement, then, managing the candidate cell group based on the determined management behavior.

Specifically, in an embodiment of the present disclosure, if a configured initial activation state of the candidate cell group is “deactivated”, the management behavior is determined as: suspending the cell group configuration of the candidate cell group. For example, if the configured initial activation state for a cell group with a cell group type of MCG is “deactivated”, the UE may suspend the cell group configuration of the MCG and set the type of the candidate cell group to MCG; if a configured initial activation state for a cell group with a cell group type of SCG is “deactivated”, the UE may suspend the cell group configuration of the SCG.

In another embodiment of the present disclosure, in a case that the configured initial activation state of the candidate cell group is “activated”, the determining the management behavior includes at least one of the following manners.

The first manner includes: activating each cell in the candidate cell group (i.e., restoring or enabling the cell group configuration of the candidate cell group), and setting a type of the candidate cell group to the corresponding initial cell type.

For example, if a configured initial activation state for a cell group with a cell group type of MCG is “activated”, the UE may restore or enable the cell group configuration of the MCG to activate the candidate cell, and set the type of the activated candidate cell group to MCG; if a configured initial activation state for a cell group with a cell group type of SCG is “activated”, the UE may restore or enable the cell group configuration of the SCG to activate the candidate cell, and set the type of the activated candidate cell group to SCG.

The second manner includes: activating a primary cell or a primary secondary cell of the candidate cell group, setting a secondary cell of the candidate cell group to an activated state, a deactivated state or a sleep state, or a secondary cell state configured by the network device or a secondary cell state agreed upon in a protocol, where the secondary cell state may include an activated state, a deactivated state or a sleep state.

For example, if a configured initial activation state for a cell group with an initial cell group type of MCG is “activated”, the UE may activate a primary cell in the MCG, and also set a secondary cell in the MCG to a deactivated state or a sleep state, or a secondary cell state configured by the network device, or a secondary cell state agreed upon in a protocol, where the secondary cell state may include an activated state, a deactivated state, or a sleep state.

If a configured initial activation state for a cell group with an initial cell group type of SCG is “activated”, the UE may activate a primary secondary cell in the SCG, and also set a secondary cell in the SCG to a deactivated state or a sleep state, or a secondary cell state configured by the network device, or a secondary cell state agreed upon in a protocol, where the secondary cell state may include an activated state, a deactivated state, or a sleep state.

For detailed introduction of the activated state, the deactivated state and the sleep state, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 1b is a flow chart of a cell management method provided by embodiments of the present disclosure. The method is performed by a UE and may be used for downlink positioning. As shown in FIG. 1b, the method may include the following steps.

Step 101b: configuration information of at least one candidate cell and/or at least one candidate cell group configured by a network device is obtained, where the configuration information includes an initial configuration state.

Step 102b: the candidate cell and/or the candidate cell group is managed based on the configuration information and the initial configuration state.

For detailed introduction of steps 101b-102b, reference may be made to the description of the above embodiments, which is not further provided herein in the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 1c is a flow chart of a cell management method provided by embodiments of the present disclosure. The method is performed by a UE and may be used for downlink positioning. As shown in FIG. 1c, the method may include the following steps.

Step 101c: configuration information of at least one candidate cell and/or at least one candidate cell group configured by a network device is obtained.

Step 102c: an initial configuration state of a candidate cell and/or of a candidate cell group is determined based on a protocol agreement.

Step 103c: the candidate cell and/or the candidate cell group is managed based on the configuration information and the initial configuration state.

For detailed introduction of steps 101c-103c, reference may be made to the description of the above embodiments, which is not further provided herein in the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 1d is a flow chart of a cell management method provided by embodiments of the present disclosure. The method is performed by a UE and may be used for downlink positioning. As shown in FIG. 1d, the method may include the following steps.

Step 101d: configuration information of at least one candidate cell and/or at least one candidate cell group configured by a network device is obtained.

Step 102d: initial state configuration information transmitted by the network device is obtained, where the initial state configuration information includes an initial configuration state of a candidate cell and/or of a candidate cell group.

Step 103d: the candidate cell and/or the candidate cell group is managed based on the configuration information and the initial configuration state.

For detailed introduction of steps 101d-103d, reference may be made to the description of the above embodiments, which is not further provided herein in the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

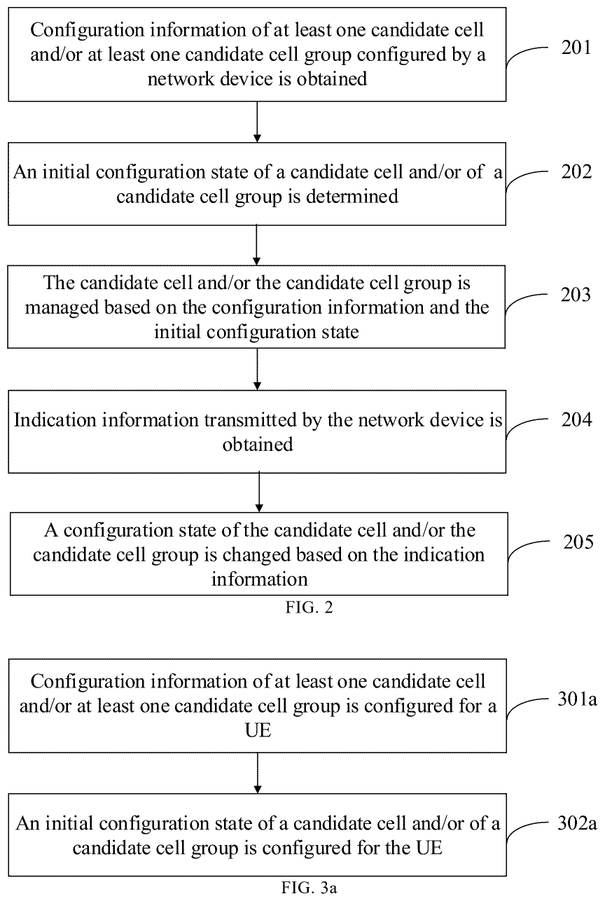

FIG. 2 is a flow chart of a cell management method provided by embodiments of the present disclosure. The method is performed by a UE and may be used for downlink positioning. As shown in FIG. 2, the method may include the following steps.

Step 201: configuration information of at least one candidate cell and/or at least one candidate cell group configured by a network device is obtained.

Step 202: an initial configuration state of a candidate cell and/or of a candidate cell group is determined.

Step 203: the candidate cell and/or the candidate cell group is managed based on the configuration information and the initial configuration state.

For detailed introduction of steps 201-203, reference may be made to the description of the above embodiments, which is not further provided herein in the present disclosure.

Step 204: indication information transmitted by the network device is obtained.

In an embodiment of the present disclosure, the indication information may be used to indicate a post-change configuration state of the candidate cell and/or the candidate cell group, and the post-change configuration state may include at least one of a post-change activation state of the candidate cell, a post-change activation state of the candidate cell group, a post-change cell type, or a post-change cell group type.

Furthermore, in an embodiment of the present disclosure, the post-change activation state may be any one of the candidate activation state described above, and the post-change activation state may be the same as or different from the configured activation state described above. The post-change cell type may be any one of the candidate cell type described above, and the post-change cell type may be the same as or different from the initial cell type. The post-change cell group type may be any one of the candidate cell group type described above, and the post-change cell group type may be the same as or different from the initial cell group type.

It should be noted that, in an embodiment of the present disclosure, the post-change configuration state needs to satisfy at least one of following conditions:
a quantity of candidate cell with a post-change cell type of PCell and with a post-change activation state of “activated” is 1;
a quantity of candidate cell with a post-change cell type of PSCell and with a post-change activation state of “activated” is 1;
in a case that a post-change activation state of a candidate cell with a post-change cell type of PCell is “deactivated”, post-change activation states of other cells belonging to a same cell group as the candidate cell are set to “deactivated”;
in a case that a post-change activation state of a candidate cell with a post-change cell type of PSCell is “deactivated”, post-change activation states of other cells belonging to a same cell group as the candidate cell are set to “deactivated”;
a quantity of candidate cell group with a post-change cell group type of MCG and with a post-change activation state of “activated” is 1; or,
a quantity of candidate cell group with a post-change cell group type of SCG and with a post-change activation state of “activated” is 1.

Further, in an embodiment of the present disclosure, the obtaining by the UE the indication information transmitted by the network device may include at least one of:
obtaining the indication information transmitted by the network device through an RRC message;
obtaining the indication information transmitted by the network device through MAC CE (Medium Access Control-Control Element) signaling; or,
obtaining the indication information transmitted by the network device through DCI (Downlink Control Information) signaling.

Step 205: a configuration state of the candidate cell and/or the candidate cell group is changed based on the indication information

Specifically, in an embodiment of the present disclosure, the changing the configuration state of the candidate cell based on the indication information may specifically include: changing the cell type of the candidate cell to the post-change cell type corresponding to the candidate cell (e.g., it is assumed that the initial cell type of candidate cell-1 is PCell, and the UE determines that the post-change cell type of candidate cell-1 is SCell based on the indication information, then the UE may change the cell type of the candidate cell-1 from PCell to SCell), and activating or deactivating the candidate cell based on the post-change activation state corresponding to the candidate cell.

It should be noted that, in an embodiment of the present disclosure, in case of activating or deactivating the candidate cell based on the post-change activation state corresponding to the candidate cell, if the post-change cell type corresponding to the candidate cell is PCell, PSCell or SpCell, the UE may directly activate or deactivate the candidate cell based on the “post-change activation state” corresponding to the candidate cell. For example, if the post-change cell type of the candidate cell-2 is PCell and the post-change activation state is “activated”, the UE may activate the candidate cell-2 as the PCell.

In addition, if the post-change cell type corresponding to the candidate cell is SCell, MCG SCell or SCG SCell, the UE needs to activate or deactivate the candidate cell based on the post-change activation state of the candidate cell and based on the secondary cell state configured by the network device and/or agreed upon in the protocol. Specifically, if the cell type of the candidate cell is SCell or MCG SCell or SCG SCell, when the post-change activation state of the candidate cell is “activated”, the UE may set the candidate cell to an activated state, a deactivated state or a sleep state based on the secondary cell state; when the post-change activation state of the candidate cell is “deactivated”, the UE may set the candidate cell to a deactivated state or a sleep state based on the secondary cell state.

In another embodiment of the present disclosure, the changing the configuration state of the candidate cell group based on the indication information may specifically include: changing the cell group type of the candidate cell group to the post-change cell group type corresponding to the candidate cell group (e.g. it is assumed that the initial cell type of the candidate group cell-1 is MCG, and the UE determines that the post-change cell type of the candidate cell group-1 is SCG based on the indication information, then the UE may change the cell group type of the candidate cell group-1 from MCG to SCG), and activating or deactivating the candidate cell based on the post-change activation state corresponding to the candidate cell group.

It should be noted that, in an embodiment of the present disclosure, the activating or deactivating the candidate cell group based on the post-change activation state corresponding to the candidate cell group may be as follows.

In a case that the post-change activation state of the candidate cell group is “deactivated”, the UE may suspend or delete the configuration of the cell group. For example, if a post-change activation state of a cell group with a cell group type of MCG is “deactivated”, the UE may suspend the cell group configuration of the MCG; if the post-change activation state of a cell group with a cell group type of SCG is “deactivated”, the UE may suspend the cell group configuration of the SCG.

Furthermore, in a case that the post-change activation state of the candidate cell group is “activated”, the UE may activate each cell in the candidate cell group (i.e., restore or enable the cell group configuration of the candidate cell group) and set the type of the candidate cell group to the corresponding post-change cell type. Or, the UE may activate a primary cell or a primary secondary cell of the candidate cell group, and set a secondary cell of the candidate cell group to a deactivated state or a sleep state, or a secondary cell state configured by the network device, or a secondary cell state agreed upon in a protocol, where the secondary cell state may include an activated state, a deactivated state, or a sleep state.

For detailed introduction of the activated state, the deactivated state and the sleep state, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

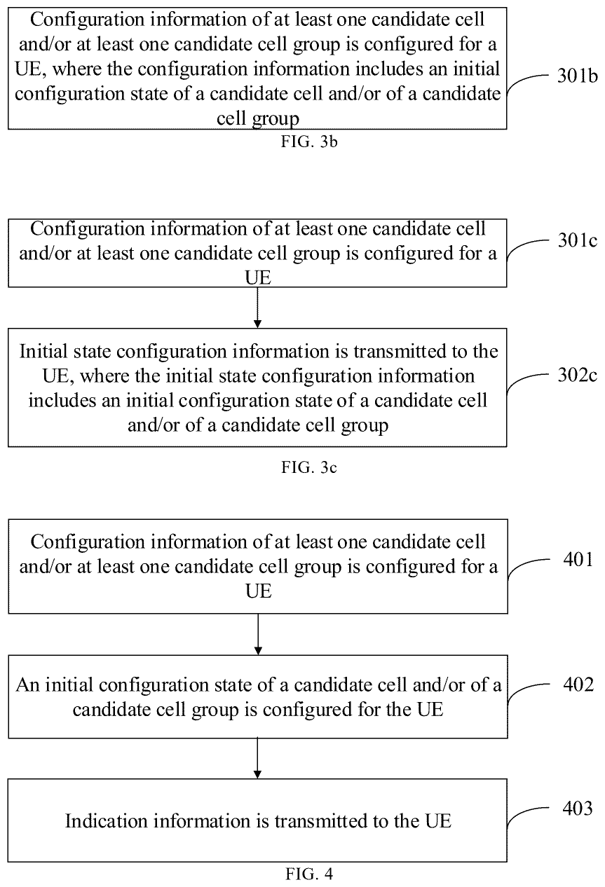

FIG. 3a is a flow chart of a cell management method provided by embodiments of the present disclosure. The method is performed by a network device and may be used for downlink positioning. As shown in FIG. 3a, the method may include the following steps.

Step 301a: configuration information of at least one candidate cell and/or at least one candidate cell group is configured for a UE.

Step 302a: an initial configuration state of a candidate cell and/or of a candidate cell group is configured for the UE, where the initial configuration state includes at least one of a configured initial activation state of the candidate cell, a configured initial activation state of the candidate cell group, an initial cell type, or an initial cell group type.

For detailed introduction of steps 301a-302a, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 3b is a flow chart of a cell management method provided by embodiments of the present disclosure. The method is performed by a network device and may be used for downlink positioning. As shown in FIG. 3b, the method may include the following steps.

Step 301b: configuration information of at least one candidate cell and/or at least one candidate cell group is configured for a UE, where the configuration information includes an initial configuration state of a candidate cell and/or of a candidate cell group.

The initial configuration state includes at least one of a configured initial activation state of the candidate cell, a configured initial activation state of the candidate cell group, an initial cell type, or an initial cell group type.

For detailed introduction of step 301b, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 3c is a flow chart of a cell management method provided by embodiments of the present disclosure. The method is performed by a network device and may be used for downlink positioning. As shown in FIG. 3c, the method may include the following steps.

Step 301c: configuration information of at least one candidate cell and/or at least one candidate cell group is configured for a UE.

Step 302c: initial state configuration information is transmitted to the UE, where the initial state configuration information includes an initial configuration state of a candidate cell and/or of a candidate cell group.

For detailed introduction of steps 301c-302c, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

FIG. 4 is a flow chart of a cell management method provided by embodiments of the present disclosure. The method is performed by a network device and may be used for downlink positioning. As shown in FIG. 4, the method may include the following steps.

Step 401: configuration information of at least one candidate cell and/or at least one candidate cell group is configured for a UE.

Step 401: an initial configuration state of a candidate cell and/or of a candidate cell group is configured for the UE, where the initial configuration state includes at least one of a configured initial activation state of the candidate cell, a configured initial activation state of the candidate cell group, an initial cell type, or an initial cell group type.

Step 403: indication information is transmitted to the UE, where the indication information is used to indicate a post-change configuration state of the candidate cell and/or the candidate cell group, and the post-change configuration state includes at least one of a post-change activation state of the candidate cell, a post-change activation state of the candidate cell group, a post-change cell type, or a post-change cell group type.

For detailed introduction of steps 401-403, reference may be made to the description of the above embodiments, which is not further provided herein in the embodiments of the present disclosure.

In conclusion, in the cell management method provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

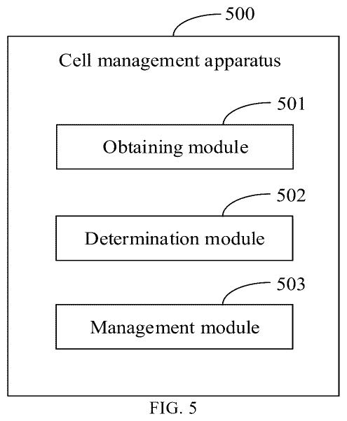

FIG. 5 is a structural diagram of a cell management apparatus provided by embodiments of the present disclosure. As shown in FIG. 5, the apparatus may include an obtaining module 501, a determination module 502, and a management module 503.

The obtaining module 501 is configured to obtain configuration information of at least one candidate cell and/or at least one candidate cell group configured by a network device.

The determination module 502 is configured to determine an initial configuration state of a candidate cell and/or of a candidate cell group, where the initial configuration state includes at least one of a configured initial activation state of the candidate cell, a configured initial activation state of the candidate cell group, an initial cell type, or an initial cell group type.

The management module 503 is configured to manage the candidate cell and/or the candidate cell group based on the configuration information and the initial configuration state.

In conclusion, in the cell management apparatus provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

Optionally, in an embodiment of the present disclosure, the configuration information includes at least one of:
a configuration identifier of the candidate cell;
a configuration identifier of the candidate cell group;
cell configuration of the candidate cell; or,
cell group configuration of the candidate cell group.

Optionally, in an embodiment of the present disclosure, the configuration information includes a configuration list, each column of the configuration list corresponds to an index, and each column of the configuration list correspondingly includes cell configuration of one candidate cell or cell group configuration of one candidate cell group, where an index of a column corresponding to each candidate cell is used to implicitly indicate a configuration identifier of the each candidate cell, and an index of a column corresponding to each candidate cell group is used to implicitly indicate a configuration identifier of the each candidate cell group.

Optionally, in an embodiment of the present disclosure, the determination module is further configured to:
determine the initial configuration state of a candidate cell and/or of a candidate cell group based on the configuration information, where the configuration information includes the initial configuration state of the candidate cell and/or of the candidate cell group; and/or
determine the initial configuration state of the candidate cell and/or of the candidate cell group based on a protocol agreement; and/or
obtain initial state configuration information transmitted by the network device, and determining the initial configuration state of the candidate cell and/or of the candidate cell group based on the initial state configuration information, where the initial state configuration information includes the initial configuration state of the candidate cell and/or of the candidate cell group.

Optionally, in an embodiment of the present disclosure, the configured initial activation state of the candidate cell is any one of a candidate activation state; the configured initial activation state of the candidate cell group is any one of the candidate activation state;
the candidate activation state includes at least one of:
an activated state; or,
a deactivated state.

Optionally, in an embodiment of the present disclosure, the initial cell type is any one of a candidate cell type;
the candidate cell type includes at least one of:
a primary cell (PCell);
a primary secondary cell (PSCell);
a special cell (SpCell);
a secondary cell (SCell);
a secondary cell of a master cell group (MCG SCell); or,
a secondary cell of a secondary cell group (SCG SCell).

Optionally, in an embodiment of the present disclosure, the initial cell group type is any one of a candidate cell group type;
the candidate cell group type includes at least one of:
a master cell group (MCG); or,
a secondary cell group (SCG).

Optionally, in an embodiment of the present disclosure, the initial configuration state of the candidate cell and/or of the candidate cell group satisfies at least one of following conditions:
a quantity of candidate cell with an initial cell type of PCell and with a configured initial activation state of “activated” is 1;
a quantity of candidate cell with an initial cell type of PSCell and with a configured initial activation state of “activated” is 1;
in a case that a configured initial activation state of a candidate cell with an initial cell type of PCell is “deactivated”, configured initial activation states of other cells belonging to a same cell group as the candidate cell are set to “deactivated”;
in a case that a configured initial activation state of a candidate cell with an initial cell type of PSCell is “deactivated”, configured initial activation states of other cells belonging to a same cell group as the candidate cell are set to “deactivated”;
a quantity of candidate cell group with an initial cell group type of MCG and with a configured initial activation state of “activated” is 1; or,
a quantity of candidate cell group with an initial cell group type of SCG and with a configured initial activation state of “activated” is 1.

Optionally, in an embodiment of the present disclosure, the management module is further configured to:
determine a management behavior corresponding to the candidate cell in each different initial configuration state based on a protocol agreement, and manage the candidate cell based on the management behavior; where
in response to the initial cell type of the candidate cell being a PCell, a PSCell or an SpCell, the management behavior is determined as: directly activating or deactivating the candidate cell based on the configured initial activation state, and setting a cell type of the activated candidate cell to the corresponding initial cell type;
in response to the initial cell type of the candidate cell being an SCell or an MCG SCell or an SCG SCell, in a case that the configured initial activation state of the candidate cell is “activated”, the management behavior is determined as: managing the candidate cell based on a secondary cell state configured by the network device and/or agreed upon in a protocol, and setting a cell type of the candidate cell to the corresponding initial cell type, where the secondary cell state includes an activated state, a deactivated state or a sleep state; and
in response to the initial cell type of the candidate cell being an SCell or an MCG SCell or an SCG SCell, in a case that the configured initial activation state of the candidate cell is “deactivated”, the management behavior is determined as: managing the candidate cell based on a secondary cell state configured by the network device and/or agreed upon in a protocol, and setting a cell type of the candidate cell to the corresponding initial cell type, where the secondary cell state includes a deactivated state or a sleep state.

Optionally, in an embodiment of the present disclosure, the management module is further configured to:
determine a management behavior corresponding to the candidate cell group in each different initial configuration state based on a protocol agreement, and manage the candidate cell group based on the management behavior; where
in a case that the configured initial activation state of the candidate cell group is “deactivated”, the management behavior is determined as: suspending cell group configuration of the candidate cell group based on the configuration information of the candidate cell group; and
in a case that the configured initial activation state of the candidate cell group is “activated”, the management behavior is determined to include at least one of:
activating each cell in the candidate cell group, and setting a cell group type of the candidate cell group to the corresponding initial cell group type; or,
activating a primary cell or a primary secondary cell of the candidate cell group, setting a secondary cell of the candidate cell group to an activated state, a deactivated state or a sleep state, or a secondary cell state configured by the network device or a secondary cell state agreed upon in a protocol, where the secondary cell state includes an activated state, a deactivated state or a sleep state, and setting a cell group type of the candidate cell group to the corresponding initial cell group type.

Optionally, in an embodiment of the present disclosure, the apparatus is further configured to:
obtain indication information transmitted by the network device, where the indication information is used to indicate a post-change configuration state of the candidate cell and/or the candidate cell group, and the post-change configuration state includes at least one of a post-change activation state of the candidate cell, a post-change activation state of the candidate cell group, a post-change cell type, or a post-change cell group type; and
change a configuration state of the candidate cell and/or the candidate cell group based on the indication information.

Optionally, in an embodiment of the present disclosure, the post-change configuration state of the candidate cell and/or the candidate cell group indicated by the indication information satisfies at least one of following conditions:
a quantity of candidate cell with a post-change cell type of PCell and with a post-change activation state of “activated” is 1;
a quantity of candidate cell with a post-change cell type of PSCell and with a post-change activation state of “activated” is 1;
in a case that a post-change activation state of a candidate cell with a post-change cell type of PCell is “deactivated”, post-change activation states of other cells belonging to a same cell group as the candidate cell are set to “deactivated”;
in a case that a post-change activation state of a candidate cell with a post-change cell type of PSCell is “deactivated”, post-change activation states of other cells belonging to a same cell group as the candidate cell are set to “deactivated”;
a quantity of candidate cell group with a post-change cell group type of MCG and with a post-change activation state of “activated” is 1; or,
a quantity of candidate cell group with a post-change cell group type of SCG and with a post-change activation state of “activated” is 1.

Optionally, in an embodiment of the present disclosure, the apparatus is further configured to:
obtain the indication information transmitted by the network device through a radio resource control (RRC) message; and/or
obtain the indication information transmitted by the network device through a medium access control-control element (MAC CE) signaling; and/or
obtain the indication information transmitted by the network device through a downlink control information (DCI) signaling.

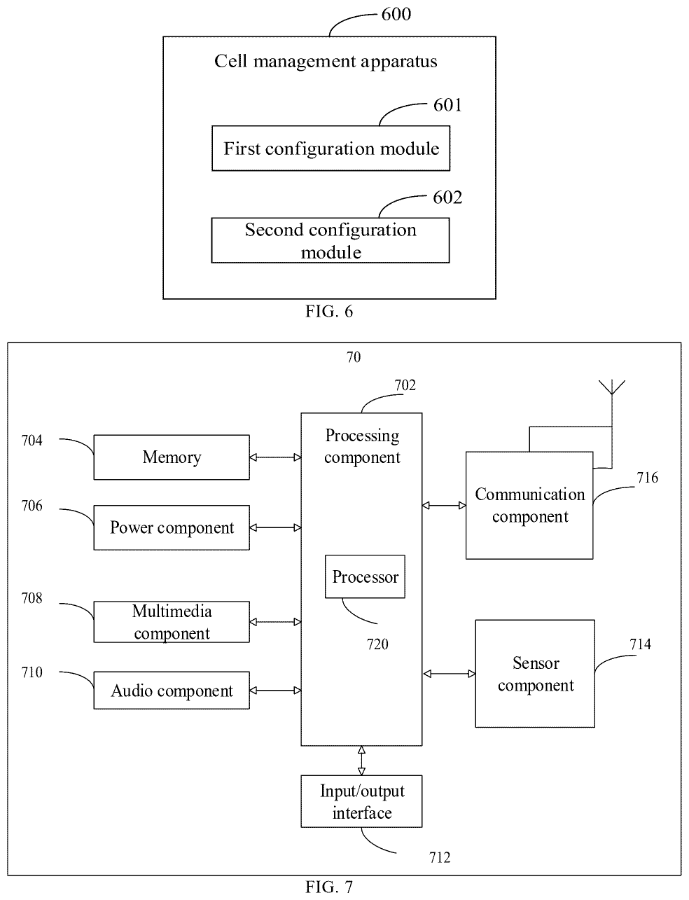

FIG. 6 is a structural diagram of a cell management apparatus provided by embodiments of the present disclosure. As shown in FIG. 6, the apparatus may include a first configuration module and a second configuration module.

The first configuration module is configured to configure configuration information of at least one candidate cell and/or at least one candidate cell group for a user equipment (UE).

The second configuration module is configured to configure an initial configuration state of a candidate cell and/or of a candidate cell group for the UE, where the initial configuration state includes at least one of a configured initial activation state of the candidate cell, a configured initial activation state of the candidate cell group, an initial cell type, or an initial cell group type.

In conclusion, in the cell management apparatus provided in the embodiments of the present disclosure, the UE may obtain the configuration information of at least one candidate cell and/or at least one candidate cell group configured by the network device, then the UE may determine the initial configuration state of the candidate cell and/or of the candidate cell group, where the initial configuration state includes at least one of the configured initial activation state of the candidate cell, the configured initial activation state of the candidate cell group, the initial cell type, or the initial cell group type. In addition, the UE may manage the candidate cell and/or candidate cell group based on the configuration information and the initial configuration state (i.e., perform selective activation of the candidate cell and/or candidate cell group). It can be seen that the embodiments of the present disclosure provide a cell management method to selectively activate the cell and/or the cell group. After a CG (Cell Group) to which the UE is connected changes, the network device does not need to reconfigure or reinitialize the configuration of the cell to be activated. Instead, the cell or the cell group can be selectively activated based on the method provided by the present disclosure directly, which reduces signaling overhead and interruption duration of CG change.

Optionally, in an embodiment of the present disclosure, the configuration information includes at least one of:
a configuration identifier of the candidate cell;
a configuration identifier of the candidate cell group;
cell configuration of the candidate cell; or,
cell group configuration of the candidate cell group.

Optionally, in an embodiment of the present disclosure, the configuration information includes a configuration list, each column of the configuration list corresponds to an index, and each column of the configuration list correspondingly includes cell configuration of one candidate cell or cell group configuration of one candidate cell group, where an index of a column corresponding to each candidate cell is used to implicitly indicate a configuration identifier of the each candidate cell, and an index of a column corresponding to each candidate cell group is used to implicitly indicate a configuration identifier of the each candidate cell group.

Optionally, in an embodiment of the present disclosure, the second configuration module is further configured to:
include the initial configuration state in the configuration information; and/or
transmit initial state configuration information to the UE, where the initial state configuration information includes the initial configuration state of a candidate cell and/or of a candidate cell group.

Optionally, in an embodiment of the present disclosure, the configured initial activation state of the candidate cell is any one of a candidate activation state; the configured initial activation state of the candidate cell group is any one of the candidate activation state;
the candidate activation state includes at least one of:
an activated state; or,
a deactivated state.

Optionally, in an embodiment of the present disclosure, the initial cell type is any one of a candidate cell type;
the candidate cell type includes at least one of:
a PCell;
a PSCell;
an SpCell;
an SCell;
an MCG SCell; or,
an SCG SCell.

Optionally, in an embodiment of the present disclosure, the initial cell group type is any one of a candidate cell group type;
the candidate cell group type includes at least one of:
an MCG; or,
an SCG.

Optionally, in an embodiment of the present disclosure, the initial configuration state of the candidate cell and/or of the candidate cell group satisfies at least one of following conditions:
a quantity of candidate cell with an initial cell type of PCell and with a configured initial activation state of “activated” is 1;
a quantity of candidate cell with an initial cell type of PSCell and with a configured initial activation state of “activated” is 1;
in a case that a configured initial activation state of a candidate cell with an initial cell type of PCell is “deactivated”, configured initial activation states of other cells belonging to a same cell group as the candidate cell are set to “deactivated”;
in a case that a configured initial activation state of a candidate cell with an initial cell type of PSCell is “deactivated”, configured initial activation states of other cells belonging to a same cell group as the candidate cell are set to “deactivated”;
a quantity of candidate cell group with an initial cell group type of MCG and with a configured initial activation state of “activated” is 1; or,
a quantity of candidate cell group with an initial cell group type of SCG and with a configured initial activation state of “activated” is 1.

Optionally, in one embodiment of the present disclosure, the apparatus is further configured to:
transmit indication information to the UE, where the indication information is used to indicate a post-change configuration state of a candidate cell and/or of a candidate cell group, and the post-change configuration state includes at least one of a post-change activation state of the candidate cell, a post-change activation state of the candidate cell group, a post-change cell type, or a post-change cell group type.

Optionally, in an embodiment of the present disclosure, the post-change configuration state of the candidate cell and/or the candidate cell group indicated by the indication information satisfies at least one of following conditions:
a quantity of candidate cell with a post-change cell type of PCell and with a post-change
activation state of “activated” is 1;
a quantity of candidate cell with a post-change cell type of PSCell and with a post-change activation state of “activated” is 1;
in a case that a post-change activation state of a candidate cell with a post-change cell type of PCell is “deactivated”, post-change activation states of other cells belonging to a same cell group as the candidate cell are set to “deactivated”;
in a case that a post-change activation state of a candidate cell with a post-change cell type of PSCell is “deactivated”, post-change activation states of other cells belonging to a same cell group as the candidate cell are set to “deactivated”;
a quantity of candidate cell group with a post-change cell group type of MCG and with a post-change activation state of “activated” is 1; or,
a quantity of candidate cell group with a post-change cell group type of SCG and with a post-change activation state of “activated” is 1.

Optionally, in an embodiment of the present disclosure, the apparatus is further configured to:
transmit the indication information to the UE through an RRC message;
transmit the indication information to the UE through an MAC CE signaling; or,
transmit the indication information to the UE through a DCI signaling.

FIG. 7 is a block diagram of a user equipment UE 700 provided by embodiments of the present disclosure. For example, the UE 700 may be a mobile phone, a computer, a digital broadcasting terminal, a message transceiver device, a game console, a tablet device, a medical device, a fitness device and a personal digital assistant.

As shown in FIG. 7, the UE 700 may include at least one of the following components: a processing component 702, a memory 704, a power component 706, a multimedia component 708, an audio component 710, an input/output (I/O) interface 712, a sensor component 713, and a communication component 716.

The processing component 702 typically controls overall operations of the UE 700, such as the operations associated with display, telephone calls, data communications, camera operations, and recording operations. The processing component 702 may include at least one processor 77 to execute instructions so as to perform all or part of the steps in the above described method. Moreover, the processing component 702 may include at least one module which facilitates the interaction between the processing component 7702 and other components. For example, the processing component 702 may include a multimedia module to facilitate the interaction between the multimedia component 708 and the processing component 702.

The memory 704 is configured to store various types of data to support the operation of the UE 700. Examples of such data include instructions for any applications or methods operated on the UE 700, contact data, phonebook data, messages, pictures, video, etc. The memory 704 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 706 provides power to various components of the UE 700. The power component 706 may include a power management system, at least one power source, and any other components associated with the generation, management, and distribution of power in the UE 700.

The multimedia component 708 includes a screen providing an output interface between the UE 700 and the user. In some embodiments, the screen may include a Liquid Crystal Display (LCD) and a Touch Panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front-facing camera and/or a rear-facing camera. When the UE 700 is in an operating mode, such as a shooting mode or a video mode, the front-facing camera and/or the rear-facing camera can receive external multimedia data. Each front-facing camera and rear-facing camera may be a fixed optical lens system or has focal length and optical zoom capability.

The audio component 710 is configured to output and/or input audio signals. For example, the audio component 710 includes a microphone (MIC) configured to receive an external audio signal when the UE 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, a button, and the like. The button may include, but is not limited to, a home button, a volume button, a starting button, and a locking button.

The sensor component 713 includes at least one sensor to provide status assessments of various aspects of the UE 700. For instance, the sensor component 713 may detect an open/closed status of the UE 700, relative positioning of components, e.g., the display and the keypad, of the UE 700, a change in position of the UE 700 or a component of the UE 700, a presence or absence of user contact with the UE 700, an orientation or an acceleration/deceleration of the UE 700, and a change in temperature of the UE 700. The sensor component 713 may include a proximity sensor configured to detect the presence of nearby objects without any physical contact. The sensor component 713 may also include a light sensor, such as a Complementary Metal Oxide Semiconductor (CMOS) or Charge-Coupled Device (CCD) image sensor, for use in imaging applications. In some embodiments, the sensor component 713 may also include an accelerometer sensor, a gyroscope sensor, a magnetic sensor, a pressure sensor, or a temperature sensor.

The communication component 716 is configured to facilitate communication, wired or wirelessly, between the UE 700 and other devices. The UE 700 can access a wireless network based on a communication standard, such as Wi-Fi, 2G or 3G, or a combination thereof. In an exemplary embodiment, the communication component 716 receives a broadcast signal or broadcast associated information from an external broadcast management system via a broadcast channel. In an exemplary embodiment, the communication component 716 further includes a Near Field Communication (NFC) module to facilitate short-range communication. For example, the NFC module may be implemented based on a RF Identification (RFID) technology, an Infrared Data Association (IrDA) technology, an Ultra-Wide Band (UWB) technology, a Blue Tooth (BT) technology, and other technologies.

In the exemplary embodiment, the UE 700 may be implemented with at least one Application Specific Integrated Circuit (ASICs), Digital Signal Processor (DSPs), Digital Signal Processing Device (DSPDs), Programmable Logic Device (PLDs), Field Programmable Gate Array (FPGAs), controller, micro-controller, microprocessor or other electronic components, for performing the above described method.

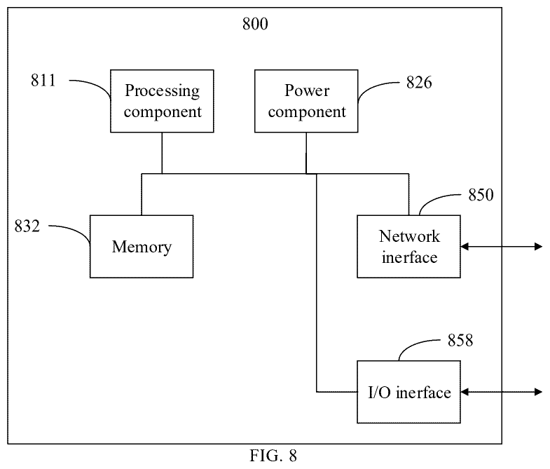

FIG. 8 is a block diagram of a network side device 800 provided by embodiments of the present disclosure. For example, the network side device 800 may be provided as a network side device. As shown in FIG. 8, the network side device 800 includes a processing component 811, which further includes at least one processor, and a memory resource represented by a memory 832 for storing instructions executable by the processing component 811, such as an application program. The application program stored in the memory 832 may include one or more modules, each of which corresponds to a set of instructions. In addition, the processing component 811 is configured to execute instructions to perform any method applied to the network side device in the above, for example, the method shown in FIG. 1.

The network side device 800 may further include a power component 826 configured to perform power management of the network side device 800, a wired or wireless network interface 850 configured to connect the network side device 800 to a network, and an input/output (I/O) interface 858. The network side device 800 may operate based on an operating system stored in the memory 832, such as Windows Server™, Mac OS X™, Unix™, Linux™, Free BSD™ or the like.

In the above embodiments of the present disclosure, the methods provided by the embodiments of the present disclosure are introduced from the perspectives of the network side device and the UE respectively. In order to implement the various functions in the methods provided by the embodiments of the present disclosure, the network side device and the UE each may include a hardware structure or a software module, and implement the above various functions in the form of a hardware structure, a software module, or a hardware structure plus a software module. Any of the above functions may be implemented in the form of a hardware structure, a software module, or a hardware structure plus a software module.

The embodiments of the present disclosure provide a communication device. The communication device may include a reception and transmission module and a processing module. The reception and transmission module may include a transmission module and/or a reception module. The transmission module is configured to implement a transmission function, and the reception module is configured to implement a reception function. The reception and transmission module may implement a transmission function and/or a reception function.

The communication device may be user equipment (such as the user equipment in the above method embodiments), or a device in the user equipment, or a device that may be used in conjunction with the user equipment. Alternatively, the communication device may be a network device, or a device in a network device, or a device that may be used in conjunction with a network device.

The embodiments of the present disclosure provide another communication device. The communication device may be a network device, or a user equipment (such as the user equipment in the above method embodiments), or a chip, chip system, or processor that supports the network device to implement the above method, or a chip, chip system, or processor that supports the user equipment to implement the above method. The device may be used to implement the method described in the above method. For details, please refer to the description in the above method embodiment. The device may be configured to implement the method described in the above method embodiments. For details, reference may be made to the description in the above method embodiments.

The communication device may include one or more processors. The processor may be a general-purpose processor or a special-purpose processor, or the like. For example, the processor may be a baseband processor or a central processing unit. The baseband processor may be configured to process communication protocols and communication data. The central processing unit may be configured to control the communication device (such as a network side device, a baseband chip, user equipment, a user equipment chip, a DU or a CU, etc.), execute a computer program, and process data for the computer program.

Optionally, the communication device may further include one or more memories, on which a computer program may be stored. The processor executes the computer program, to cause the communication device to perform the method described in the above method embodiments. Optionally, the memory may also store data. The communication device and the memory may be arranged separately or integrated together.

Optionally, the communication device may further include a transceiver and an antenna. The transceiver may be referred to as a reception and transmission unit, a transceiver unit, a reception and transmission circuit, etc., and is configured to implement reception and transmission functions. The transceiver may include a receiver and a transmitter. The receiver may be called a receiver unit or a reception circuit, etc., configured to implement the reception function; the transmitter may be referred to as a transmitter unit, a transmission circuit, etc., configured to implement the transmission function.

Optionally, the communication device may further include one or more interface circuits. The interface circuit is configured to receive code instructions and transmit them to the processor. The processor executes the code instructions to cause the communication device to perform the method described in the above method embodiments.

The communication device is user equipment (such as the user equipment in the above method embodiments): the processor is configured to perform any method shown in FIGS. 1 to 4.

The communication device is a network device: the transceiver is configured to perform any method shown in FIGS. 5 to 7.

In an implementation, the processor may include a transceiver for implementing reception and transmission functions. For example, the transceiver may be a reception and transmission circuit, an interface, or an interface circuit. The reception and transmission circuit, the interface or the interface circuit configured to implement the reception and transmission functions may be separated or integrated together. The above reception and transmission circuit, interface or interface circuit may be configured for reading and writing codes/data, or the above reception and transmission circuit, interface or interface circuit may be configured for signal transmission or transfer.

In an implementation, the processor may store a computer program, and the computer program is executed on the processor, to cause the communication device to perform the method described in the above method embodiments. The computer program may be embedded in the processor, and in this case, the processor may be implemented by hardware.

In an implementation, the communication device may include a circuit, and the circuit may implement functions of reception or transmission or communication in the above method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or user equipment (such as the user equipment in the above method embodiments), but the scope of the communication device described in the present disclosure is not limited thereto, and the structure of the communication device may not be limited thereto. The communication device may be a stand-alone device or may be part of a larger device. For example, the communication device may be:
(1) an independent integrated circuit (IC), or chip, or chip system or subsystem;
(2) a collection of one or more ICs, where, optionally, the IC collection may also include a storage component for storing data and computer programs;
(3) ASIC, such as modem;
(4) a module that can be embedded into other devices;
(5) a receiver, user equipment, intelligent user equipment, a cellular phone, a wireless equipment, a handheld device, a mobile unit, a vehicle-mounted device, a network device, a cloud device, an artificial intelligence device, etc.;
(6) others, etc.

For a case where the communication device may be a chip or a chip system, the chip includes a processor and an interface. A quantity of processor may be one or more, and a quantity of interfaces may be multiple.

Optionally, the chip further includes a memory, and the memory is configured to store needed computer programs and data.

Various illustrative logical blocks and steps listed in the embodiments of the present disclosure can be implemented by electronic hardware, computer software, or a combination of both. Whether such functions are implemented in hardware or software depends on the specific application and the overall system design requirement. In some embodiments, various methods may be used to implement the described functions for each specific application, but such implementation should not be understood as exceeding the protection scope of the embodiments of the present disclosure.

The embodiments of the present disclosure further provide a system for managing a cell, and the system includes the communication device serving as the user equipment (such as the user equipment in the above method embodiments) and the communication device serving as the network device in the above embodiments, or the system includes the communication device serving as the user equipment (such as the user equipment in the above method embodiments) and the communication device serving as the network device in the above embodiments.

The present disclosure further provides a readable storage medium, on which instructions are stored. When the instructions are executed by a computer, functions of any of the above method embodiments are implemented.

The present disclosure further provides a computer program product. The computer program product is executed by a computer to implement functions of any of the above method embodiments.

The above embodiments may be implemented in whole or in part by software, hardware, firmware, or any combination thereof. When implemented using software, it may be implemented in whole or in part in the form of a computer program product. The computer program product includes one or more computer programs. When the computer program is loaded and executed on a computer, the processes or functions described in the embodiments of the present disclosure are generated in whole or in part. The computer may be a general-purpose computer, a special-purpose computer, a computer network, or other programmable device. The computer program may be stored in a computer readable storage medium or transferred from a computer readable storage medium to another computer readable storage medium. For example, the computer program may be transferred from a website, computer, server, or data center to another website, computer, server or data center through wired means (such as coaxial cable, optical fiber, digital subscriber line (DSL)) or wireless means (such as infrared, radio, microwave, etc.). The computer readable storage medium may be any available medium that can be accessed by a computer or a data storage device integrated by one or more available media, which includes a server, a data center, and so on. The available medium may be a magnetic medium (e.g., floppy disk, hard disk, magnetic tape), optical medium (e.g., high-density digital video disc (DVD)), or semiconductor medium (e.g., solid state disk (SSD)) etc.

The first, second, and other numerical numbers involved in the present disclosure are only for convenience of description and are not used to limit the scope of the embodiments of the present disclosure, or to indicate the order.

At least one in the present disclosure may also be described as one or more, and multiple may be two, three, four or more, which are not limited by the present disclosure. In the embodiments of the present disclosure, technical features are distinguished by terms “first”, “second”, “third”, “A”, “B”, “C” and “D”, etc. The technical features described by the terms “first”, “second”, “third”, “A”, “B”, “C” and “D” are not in an order of precedence or in an order of size.

This application is intended to cover any variations, uses, or adaptations of the disclosure following the general principles thereof and including such departures from the disclosure as come within known or customary practice in the art. It is intended that the specification and examples be considered as exemplary only, with a true scope of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

1. A cell management method, comprising:
obtaining, by a user equipment (UE), configuration information of at least one of at least one candidate cell or at least one candidate cell group configured by a network device;
determining, by the UE, an initial configuration state of at least one of a candidate cell or a candidate cell group, wherein the initial configuration state comprises at least one of a configured initial activation state of the candidate cell, a configured initial activation state of the candidate cell group, an initial cell type, or an initial cell group type; and
managing, by the UE, at least one of the candidate cell or the candidate cell group based on the configuration information and the initial configuration state.

2. The cell management method according to claim 1, wherein the configuration information comprises at least one of following information:
a configuration identifier of the candidate cell;
a configuration identifier of the candidate cell group;
cell configuration of the candidate cell; or,
cell group configuration of the candidate cell group;
wherein the initial cell type is any one of at least one candidate cell type; and the at least one candidate cell type comprises at least one of: a primary cell (PCell); a primary secondary cell (PSCell); a special cell (SpCell); a secondary cell (SCell); a secondary cell of a master cell group (MCG SCell); or a secondary cell of a secondary cell group (SCG SCell);
wherein the initial cell group type is any one of at least one candidate cell group type; and the at least one candidate cell group type comprises at least one of a master cell group (MCG) or a secondary cell group (SCG).

3. The cell management method according to claim 1, wherein the configuration information comprises a configuration list, each column of the configuration list corresponds to an index, and each column of the configuration list comprises cell configuration of one candidate cell or cell group configuration of one candidate cell group,
wherein an index of a column corresponding to each candidate cell is used to implicitly indicate a configuration identifier of each candidate cell, and an index of a column corresponding to each candidate cell group is used to implicitly indicate a configuration identifier of each candidate cell group.

4. The cell management method according to claim 1, wherein determining the initial configuration state of at least one of the candidate cell or of the candidate cell group comprises at least one of:
determining the initial configuration state of at least one of the candidate cell or the candidate cell group based on the configuration information, wherein the configuration information comprises the initial configuration state of at least one of the candidate cell or of the candidate cell group;
determining the initial configuration state of at least one of the candidate cell or the candidate cell group based on a protocol agreement; or,
obtaining initial state configuration information transmitted by the network device, and determining the initial configuration state of at least one of the candidate cell or the candidate cell group based on the initial state configuration information, wherein the initial state configuration information comprises the initial configuration state of at least one of the candidate cell or the candidate cell group.

5. The cell management method according to claim 1, wherein the configured initial activation state of the candidate cell is any one of at least one candidate activation state, or the configured initial activation state of the candidate cell group is any one of the at least one candidate activation state;
wherein the at least one candidate activation state comprises at least one of:
an activated state; or,
a deactivated state.

6-7. (canceled)

8. The cell management method according to claim 1, wherein the initial configuration state of at least one of the candidate cell or the candidate cell group satisfies at least one of following conditions:
a quantity of first candidate cell with an initial cell type of PCell and with a configured initial activation state of “activated” is 1;
a quantity of second_candidate cell with an initial cell type of PSCell and with a configured initial activation state of “activated” is 1;
in a case that a configured initial activation state of a third candidate cell with an initial cell type of PCell is “deactivated”, configured initial activation states of other cells belonging to a same cell group as the third candidate cell are set to “deactivated”;
in a case that a configured initial activation state of a fourth candidate cell with an initial cell type of PSCell is “deactivated”, configured initial activation states of other cells belonging to a same cell group as the fourth candidate cell are set to “deactivated”;
a quantity of first candidate cell group with an initial cell group type of MCG and with a configured initial activation state of “activated” is 1; or,
a quantity of second_candidate cell group with an initial cell group type of SCG and with a configured initial activation state of “activated” is 1.

9. The cell management method according to claim 5, wherein managing the candidate cell based on the configuration information and the initial configuration state comprises:
determining a management behavior corresponding to the candidate cell in the initial configuration state based on a protocol agreement, and managing the candidate cell based on the management behavior;
wherein different initial configuration states correspond to different management behaviors,
in response to the initial cell type of the candidate cell being one of a PCell, a PSCell or an SpCell, the management behavior is determined as: directly activating or deactivating the candidate cell based on the configured initial activation state, and setting a cell type of the activated candidate cell to the corresponding initial cell type;,
in response to the initial cell type of the candidate cell being one of an SCell, an MCG SCell or an SCG SCell, in a case that the configured initial activation state of the candidate cell is “activated”, the management behavior is determined as: managing the candidate cell based on at least one of a secondary cell state configured by the network device or a secondary cell state agreed upon in a protocol, and setting a cell type of the candidate cell to the corresponding initial cell type, wherein the secondary cell state comprises an activated state, a deactivated state or a sleep state, and
in response to the initial cell type of the candidate cell being one of an SCell, an MCG SCell or an SCG SCell, in a case that the configured initial activation state of the candidate cell is “deactivated”, the management behavior is determined as: managing the candidate cell based on at least one of a secondary cell state configured by the network device or a secondary cell state agreed upon in a protocol, and setting a cell type of the candidate cell to the corresponding initial cell type, wherein the secondary cell state comprises a deactivated state or a sleep state;
or
wherein managing the candidate cell group based on the configuration information and the initial configuration state comprises:
determining a management behavior corresponding to the candidate cell group in the initial configuration state based on a protocol agreement, and managing the candidate cell group based on the management behavior;
wherein different initial configuration states correspond to different management behaviors,
in a case that the configured initial activation state of the candidate cell group is “deactivated”, the management behavior is determined as: suspending cell group configuration of the candidate cell group based on the configuration information of the candidate cell group, and
in a case that the configured initial activation state of the candidate cell group is “activated”, the management behavior is determined to comprise at least one of:
activating each cell in the candidate cell group, and setting a cell group type of the candidate cell group to a corresponding initial cell group type; or,
activating a primary cell or a primary secondary cell of the candidate cell group, and setting a secondary cell of the candidate cell group to an activated state, a deactivated state, a sleep state, a secondary cell state configured by the network device, or a secondary cell state agreed upon in a protocol, wherein the secondary cell state comprises an activated state, a deactivated state, or a sleep state; and
setting a cell group type of the candidate cell group to a corresponding initial cell group type.

10. (canceled)

11. The cell management method according to claim 1, further comprising:
obtaining, by the UE, indication information transmitted by the network device, wherein the indication information is used to indicate a post-change configuration state of at least one of the candidate cell or the candidate cell group, and the post-change configuration state comprises at least one of a post-change activation state of the candidate cell, a post-change activation state of the candidate cell group, a post-change cell type, or a post-change cell group type; and
changing, by the UE, a configuration state of at least one of the candidate cell or the candidate cell group based on the indication information.

12. The cell management method according to claim 11, wherein the post-change configuration state of at least one of the candidate cell or the candidate cell group indicated by the indication information satisfies at least one of following conditions:
a quantity of first candidate cell with a post-change cell type of PCell and with a post-change activation state of “activated” is 1;
a quantity of second candidate cell with a post-change cell type of PSCell and with a post-change activation state of “activated” is 1;
in a case that a post-change activation state of a third candidate cell with a post-change cell type of PCell is “deactivated”, post-change activation states of other cells belonging to a same cell group as the third candidate cell are set to “deactivated”;
in a case that a post-change activation state of a fourth candidate cell with a post-change cell type of PSCell is “deactivated”, post-change activation states of other cells belonging to a same cell group as the fourth candidate cell are set to “deactivated”;
a quantity of first candidate cell group with a post-change cell group type of MCG and with a post-change activation state of “activated” is 1; or,
a quantity of second candidate cell group with a post-change cell group type of SCG and with a post-change activation state of “activated” is 1;
or
wherein obtaining the indication information transmitted by the network device comprises:
obtaining the indication information transmitted by the network device through a radio resource control (RRC) message;
obtaining the indication information transmitted by the network device through a medium access control-control element (MAC CE) signaling; or,
obtaining the indication information transmitted by the network device through a downlink control information (DCI) signaling.

13. (canceled)

14. A cell management method, comprising:
configuring, by a network device, configuration information of at least one of at least one candidate cell or at least one candidate cell group for a user equipment (UE); and
configuring, by the network device, an initial configuration state of at least one of a candidate cell or a candidate cell group for the UE, wherein the initial configuration state comprises at least one of a configured initial activation state of the candidate cell, a configured initial activation state of the candidate cell group, an initial cell type, or an initial cell group type.

15. The cell management method according to claim 14, wherein the configuration information comprises at least one of following information:
a configuration identifier of the candidate cell;
a configuration identifier of the candidate cell group;
cell configuration of the candidate cell; or,
cell group configuration of the candidate cell group;
wherein the initial cell type is any one of at least one candidate cell type; and the at least one candidate cell type comprises at least one of: a primary cell (PCell); a primary secondary cell (PSCell); a special cell (SpCell); a secondary cell (SCell); a secondary cell of a master cell group (MCG SCell); or a secondary cell of a secondary cell group (SCG SCell);
wherein the initial cell group type is any one of at least one candidate cell group type; and the at least one candidate cell group type comprises at least one of: a master cell group (MCG); or a secondary cell group (SCG).

16. The cell management method according to claim 14, wherein the configuration information comprises a configuration list, each column of the configuration list corresponds to an index, and each column of the configuration list comprises cell configuration of one candidate cell or cell group configuration of one candidate cell group, and
wherein an index of a column corresponding to each candidate cell is used to implicitly indicate a configuration identifier of each candidate cell, and an index of a column corresponding to each candidate cell group is used to implicitly indicate a configuration identifier of each candidate cell group.

17. The cell management method according to claim 14, wherein configuring the initial configuration state of at least one of the candidate cell or the candidate cell group for the UE comprises at least one of:
including the initial configuration state in the configuration information; or,
transmitting initial state configuration information to the UE, wherein the initial state configuration information comprises the initial configuration state of at least one of the candidate cell or the candidate cell group.

18. The cell management method according to claim 14, wherein the configured initial activation state of the candidate cell is any one of at least one candidate activation state; the configured initial activation state of the candidate cell group is any one of the at least one candidate activation state;
wherein the at least one candidate activation state comprises at least one of:
an activated state; or,
a deactivated state.

19-20. (canceled)

21. The cell management method according to claim 14, wherein the initial configuration state of at least one of the candidate cell or the candidate cell group satisfies at least one of following conditions:
a quantity of first candidate cell with an initial cell type of PCell and with a configured initial activation state of “activated” is 1;
a quantity of second_candidate cell with an initial cell type of PSCell and with a configured initial activation state of “activated” is 1;
in a case that a configured initial activation state of a third candidate cell with an initial cell type of PCell is “deactivated”, configured initial activation states of other cells belonging to a same cell group as the third candidate cell are set to “deactivated”;
in a case that a configured initial activation state of a fourth candidate cell with an initial cell type of PSCell is “deactivated”, configured initial activation states of other cells belonging to a same cell group as the fourth candidate cell are set to “deactivated”;
a quantity of first candidate cell group with an initial cell group type of MCG and with a configured initial activation state of “activated” is 1; or,
a quantity of second candidate cell group with an initial cell group type of SCG and with a configured initial activation state of “activated” is 1.

22. The cell management method according to claim 14, further comprising:
transmitting, by the network device, indication information to the UE, wherein the indication information is used to indicate a post-change configuration state of at least one of the candidate cell or the candidate cell group, and the post-change configuration state comprises at least one of a post-change activation state of the candidate cell, a post-change activation state of the candidate cell group, a post-change cell type, or a post-change cell group type.

23. The cell management method according to claim 22, wherein the post-change configuration state of at least one of the candidate cell or the candidate cell group indicated by the indication information satisfies at least one of following conditions:
a quantity of first candidate cell with a post-change cell type of PCell and with a post-change activation state of “activated” is 1;
a quantity of second candidate cell with a post-change cell type of PSCell and with a post-change activation state of “activated” is 1;
in a case that a post-change activation state of a third candidate cell with a post-change cell type of PCell is “deactivated”, post-change activation states of other cells belonging to a same cell group as the third candidate cell are set to “deactivated”;
in a case that a post-change activation state of a fourth candidate cell with a post-change cell type of PSCell is “deactivated”, post-change activation states of other cells belonging to a same cell group as the fourth candidate cell are set to “deactivated”;
a quantity of first candidate cell group with a post-change cell group type of MCG and with a post-change activation state of “activated” is 1; or,
a quantity of second candidate cell group with a post-change cell group type of SCG and with a post-change activation state of “activated” is 1.

24. The cell management method according to claim 22, wherein transmitting the indication information to the UE comprises:
transmitting the indication information to the UE through a radio resource control (RRC) message;
transmitting the indication information to the UE through a medium access control-control element (MAC CE) signaling; or,
transmitting the indication information to the UE through a downlink control information (DCI) signaling.

25-26. (canceled)

27. A user equipment, comprising a processor and a memory, wherein a computer program is stored in the memory, and the processor is configured to:
obtain configuration information of at least one of at least one candidate cell or at least one candidate cell group configured by a network device;
determine an initial configuration state of at least one of a candidate cell or a candidate cell group, wherein the initial configuration state comprises at least one of a configured initial activation state of the candidate cell, a configured initial activation state of the candidate cell group, an initial cell type, or an initial cell group type; and
manage at least one of the candidate cell or the candidate cell group based on the configuration information and the initial configuration state.

28. A network device, comprising a processor and a memory, wherein a computer program is stored in the memory, and the processor is configured to execute the computer program stored in the memory to cause the communication device to perform the cell management method according to claim 14.

29-32. (canceled)
